(19) United States
(12) Patent Application Publication
(10) Pub. No.: US 2026/0208639 A1
(43) Pub. Date: Jul. 23, 2026

(54) VEHICLE SEAT

(71) Applicant: TACHI-S CO., LTD., Tokyo (JP)

(72) Inventor: Nozomi SHIMIZU, Tokyo (JP)

(73) Assignee: TACHI-S CO., LTD., Tokyo (JP)

(21) Appl. No.: 19/428,413

(22) Filed: Dec. 22, 2025

(30) Foreign Application Priority Data
Jan. 20, 2025 (JP) 2025-007936

(51) Int. Cl. B60N 2/60; B60N 2/10

(52) U.S. Cl. CPC B60N 2/6027; B60N 2/10

(57) ABSTRACT

A vehicle seat is provided which is capable of preventing abnormal noises generated due to collision with a frame at a time of deforming a resin plate. In the vehicle seat, a resin plate has: a plate body configured to cover a rear side of a frame; a locking claw configured to lock the frame; and a plurality of ribs protruding toward the frame. When the resin plate is mounted to the frame via the locking claw, the plurality of ribs abut against the frame, and a predetermined gap is formed between the frame and the plate body. The predetermined gap is greater than the dimension obtained by adding the maximum deflection of the plate body when subjected to an external force in a direction perpendicular to the in-plane direction to the dimensional tolerance of the plate body.

### CROSS-REFERENCE TO RELATED APPLICATION

The present application claims priority to Japanese patent application JP 2025-007936, filed Jan. 20, 2025, the entire contents of which are being incorporated herein by reference.

### BACKGROUND OF THE INVENTION

This invention relates to a vehicle seat.

Generally, the seat back of a vehicle seat includes a cushion member provided on the side where the occupant's back rests, a frame supporting the cushion member, and a rear panel covering the rear surface of the frame. The rear panel is, for example, a resin plate molded from resin.

For example, a vehicle seat described in Japanese Unexamined Patent Application Publication No. 2023-122112 includes a resin plate with a plurality of bosses formed at positions facing a seat back frame (frame). When the resin plate is in an unloaded state, the height dimension is configured such that some of the bosses are in contact with the seat back frame, while the remaining bosses are not in contact with the seat back frame. When a load is applied in the direction of the seat back frame and the resin plate is deformed, the height dimension is configured such that some of the bosses and the remaining bosses are in contact with the seat back frame. Thus, regardless of the dimensional error of the bosses of the resin plate, the bosses are in contact with the seat back frame in any states of the resin plate is in an unloaded state and in a loaded state.

### SUMMARY OF THE INVENTION

In the vehicle seat disclosed in the above Japanese Unexamined Patent Application Publication No. 2023-122112, when the resin plate is unloaded and when it is loaded, the bosses of the resin plate are in contact with the seat back frame, thereby suppressing deformation of the resin plate. However, it is not possible to completely eliminate the deformation of the resin plate. Therefore, when the resin plate deflects under load, the bosses of the resin plate collide with the seat back frame, causing an unpleasant noise (called reverberation).

It is therefore a primary object of the present invention to provide a vehicle seat which is capable of preventing abnormal noises generated due to collision with the frame at a time of deforming the resin plate.

In order to achieve the above object, the present invention provides a vehicle seat which includes: a frame; and a resin plate supported by the frame. In the vehicle seat, the resin plate has: a plate body configured to cover a rear side of the frame; a locking claw configured to lock the frame; and a plurality of ribs protruding toward the frame. When the resin plate is mounted to the frame via the locking claw, the plurality of ribs abut against the frame, and a predetermined gap is formed between the frame and the plate body. The predetermined gap is greater than a dimension obtained by adding a maximum deflection of the plate body when subjected to an external force in a direction perpendicular to an in-plane direction to a dimensional tolerance of the plate body.

In the above configuration, the resin plate includes a plurality of the locking claws, the frame is formed to be a rectangle, and the locking claws are provided in a number equal to or greater than the number of four edges forming the rectangle of the frame and are arranged at positions to lock the four edges.

In the above configuration, the resin plate includes the ribs equal to or greater in number than the locking claws, and the ribs may be arranged between each pair of the locking claws along the seat back frame.

In the above configuration, the frame is constituted by a pipe having a flat surface on a portion of the outer peripheral surface of the pipe, and the locking claw abuts against the flat surface.

In the above configuration, the seat back frame includes a locking mechanism configured to restrict movement of the seat back frame relative to the vehicle, and the ribs are arranged at positions protruding toward the locking mechanism.

According to the present invention, it is possible to prevent abnormal noises generated due to collision with the frame at a time of deforming the resin plate. Objects, configurations, and effects other than the above will be apparent from the description of the following embodiments.

### BRIEF DESCRIPTION OF THE DRAWINGS

FIG. 1 is a perspective view of a vehicle seat according to an embodiment of the present invention;

FIGS. 2A and 2B are side views of the vehicle seat illustrated in FIG. 1, in which FIG. 2A illustrates a seat back in an upright position, and FIG. 2B illustrates the seat back in a reclined position;

FIG. 3 is a cross-sectional view taken along line III-III in FIG. 2A;

FIG. 4 is a cross-sectional view taken along line IV-IV in FIG. 3;

FIG. 5 is a perspective view illustrating the state in which seat back pads and seat cushions are removed and frames are combined with resin plates in the vehicle seat according to the embodiment;

FIG. 6 is a perspective view of seat back frames and the resin plates in the vehicle seat according to the embodiment;

FIG. 7 is a partially enlarged view of FIG. 6;

FIG. 8 is a partially enlarged view of FIG. 4;

FIG. 9 is a cross-sectional view taken along line IX-IX in FIG. 5; and

FIG. 10 is an explanatory diagram illustrating a gap between a seat back frame and a plate body.

### DETAILED DESCRIPTION OF THE PREFERRED EMBODIMENTS

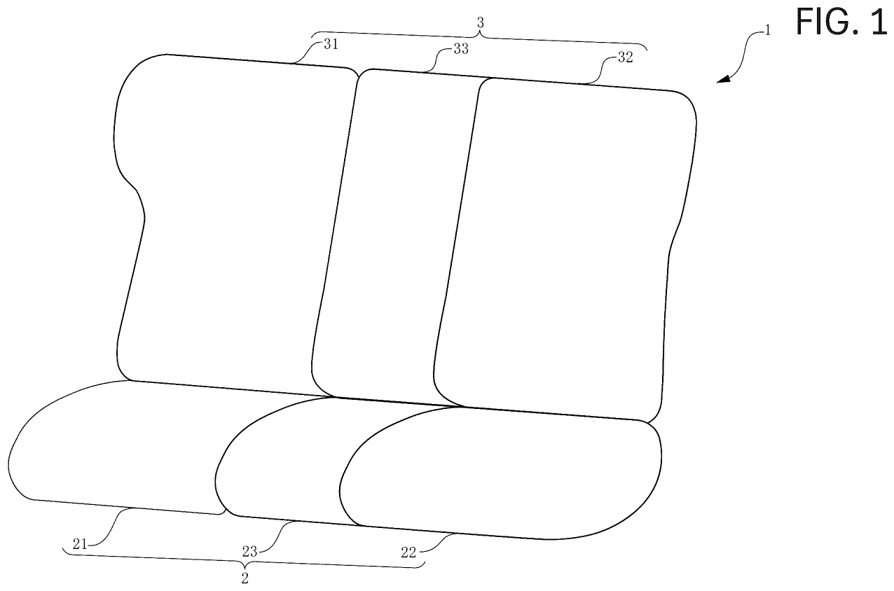

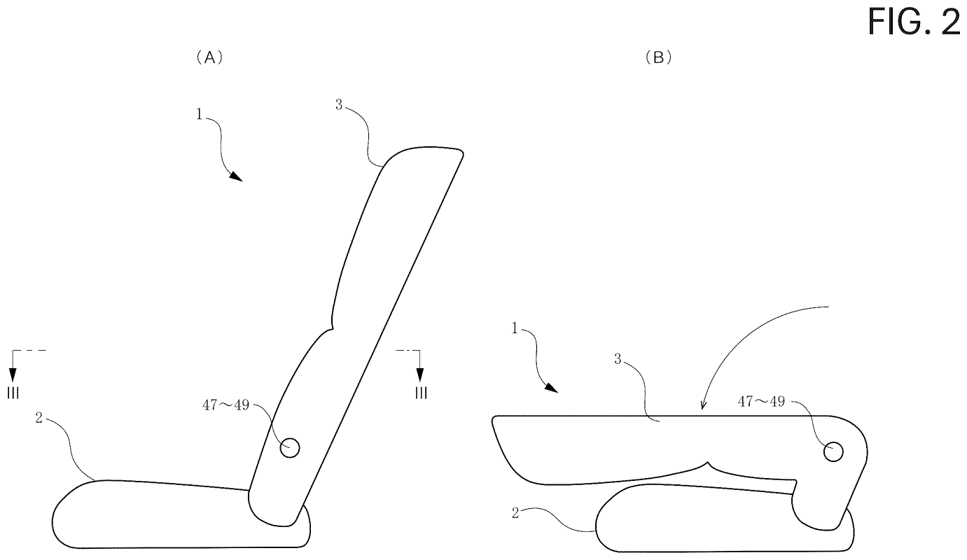

Hereinafter, a vehicle seat according to the present invention will be described with reference to the drawings. FIG. 1 is a perspective view of a vehicle seat 1 according to an embodiment of the present invention. FIGS. 2A and 2B are side views of the vehicle seat.

### Configuration of Vehicle Seat 1

As illustrated in FIG. 1, the vehicle seat 1 is a vehicle seat for the rear seats of a vehicle, and includes a seat cushion 2, and a seat back 3 mounted on the seat cushion 2 so as to be tiltable forward. The seat cushion 2 forms a seating surface for the occupant, and the seat back 3 forms a backrest for the occupant.

Note that an actual vehicle seat is equipped with a headrest mounted on the upper side (top surface) of the seat back 3, a reclining mechanism for adjusting the angle of the seat back 3 relative to the seat cushion 2, and the like. However, since these components are not directly related to the present invention, their configurations will not be illustrated or described.

In this example, the vehicle seat 1 is configured to accommodate up to three people. Therefore, the seat cushion 2 includes a seat cushion portion (right-side seat cushion portion) 21 for the right-side occupant, a seat cushion portion (left-side seat cushion portion) 22 for the left-side occupant, and a seat cushion portion (central seat cushion portion) 23 for the center occupant provided between the seat cushion portion 21 and the seat cushion portion 22. The seat cushion portions 21 to 23 are integrally formed and fixed to the vehicle's floor panel (not illustrated).

Meanwhile, in this example, the seat back 3 includes a seat back portion (right-side seat back portion) 31 for the right-side occupant, a seat back portion (left-side seat back portion) 32 for the left-side occupant, and a seat back portion (central seat back portion) 33 for the center occupant provided between the seat back portion 31 and the seat back portion 32, corresponding to the seat cushion portions 21 to 23, respectively.

Furthermore, in this example, the seat back 3 is divided into a 4:6 split, and the upper portion of the seat back portion 31 corresponding to portion 4 of the 4:6 split can be folded forward integrally about the lower portion of the seat back portion 31. Moreover, the seat back portions 32 and 33 corresponding to portion 6 of the 4:6 split are integrally provided, and the upper portions of seat back portions 32 and 33 can be folded forward integrally about the lower portion of the seat back portions 32 and 33.

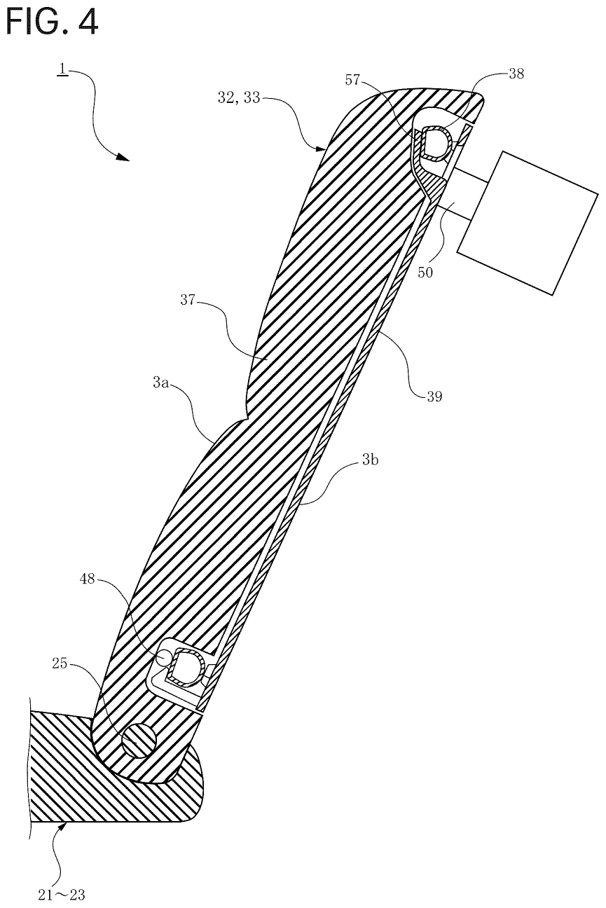

FIG. 2A is a side view illustrating the vehicle seat 1 with the seat back 3 in an upright position (a state where the occupant's back can be supported), and FIG. 2B is a side view illustrating the seat back 3 in a position folded down toward the seat cushion 2. Note that in the following description, in the state illustrated in FIG. 2A, the side of the seat back 3 against which the occupant's back rests will be referred to as a front side 3a (see FIG. 4), and the opposite side from the front side 3a will be referred to as a rear side 3b (see FIG. 4).

As illustrated in FIG. 2B, by folding the seat back 3 down onto the seat cushion 2, the rear side 3b of the seat back 3 (the upper surface of the seat back 3 in FIG. 2B) can be made nearly parallel to the unillustrated floor surface (the lower side of the seat cushion 2 in FIG. 2) of the vehicle, thereby enabling the placement of luggage on the upper surface of the seat back 3.

### Configuration of Seat Back Portions 31 to 33

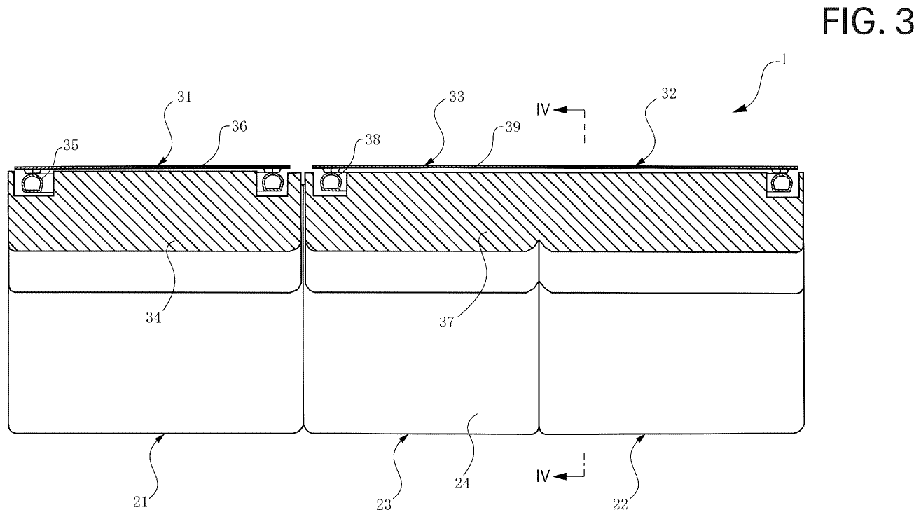

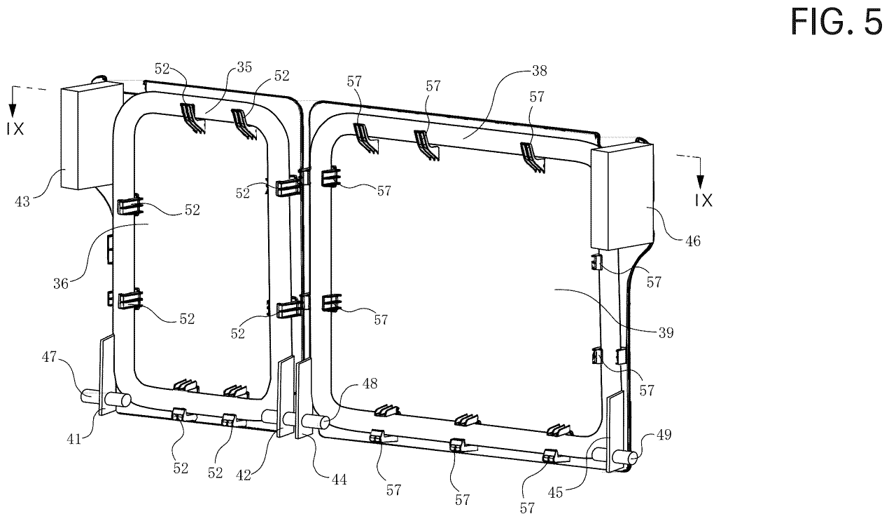

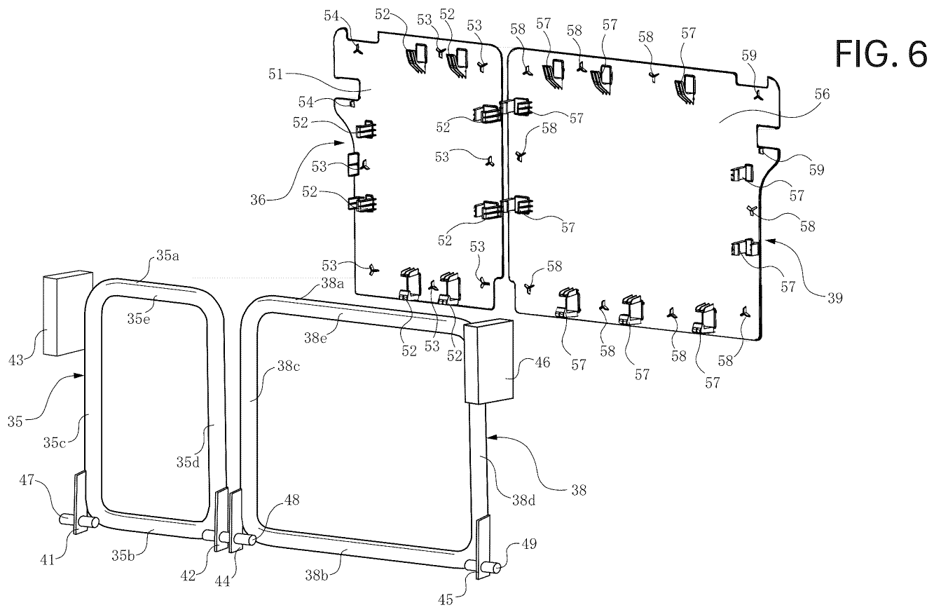

The detailed configuration of the seat back portions 31 to 33 will be described below with reference to FIGS. 3 to 6. FIG. 3 is a cross-sectional view taken along line III-III in FIG. 2A. FIG. 4 is a cross-sectional view taken along line IV-IV in FIG. 3. FIG. 5 is a perspective view illustrating the state in which seat back pads 34 and 37 and the seat cushion portions 21 to 23 are removed, and seat back frames 35 and 38 (frames) are combined with resin plates 36 and 39. FIG. 6 is a perspective view of the seat back frames 35 and 38 and the resin plates 36 and 39.

As illustrated in FIGS. 3 and 4, the seat back portion 31 includes the seat back pad 34, the seat back frame 35, and the resin plate 36 supported by the seat back frame 35. The seat back portions 32 and 33, as described above, are integrally formed, and therefore include common components, namely, the seat back pad 37, the seat back frame 38, and the resin plate 39 supported by the seat back frame 38. Furthermore, similarly, the seat cushion portions 21 to 23 are also integrally formed, and therefore include common components, namely, the seat cushion pad (not illustrated) and a seat cushion frame 25 (see FIG. 4).

The seat cushion frame 25 and the seat back frames 35 and 38 are rotatably connected via a rotation device (not illustrated). When the seat back portion 31 is folded toward the seat cushion portions 21 to 23, the resin plate 36 is located on the upper surfaces of the seat back portion 31. In other words, it becomes possible to place luggage on the upper surface of the resin plate 36. Similarly, when the seat back portions 32 and 33 are folded toward the seat cushion portions 21 to 23, the resin plate 39 is located on the upper surface of the seat back portions 32 and 33. In other words, it becomes possible to place luggage on the upper surface of the resin plate 39.

### Configuration of Seat Back Frames 35 and 38

As illustrated in FIG. 6, the seat back frame 35 has a rectangular frame shape having an upper edge 35a, a lower edge 35b, and a pair of side edges 35c and 35d. More specifically, the seat back frame 35 has a rectangular frame shape where the upper edge 35a and the lower edge 35b are shorter than the pair of side edges 35c and 35d. The seat back frame 35 is formed, for example, from a metal material.

The seat back frame 35 also includes bearings 41 and 42 and a locking mechanism 43. The upper edge 35a, the lower edge 35b, and the pair of side edges 35c and 35d are formed from a hollow pipe (more specifically, a pipe having a D-shaped cross section).

The bearings 41 and 42 are arranged at the corners where the lower edge 35b is connected to the pair of side edges 35c and 35d. The bearings 41 and 42 are provided integrally with the pair of side edges 35c and 35d. The bearings 41 and 42 are supported by support shafts 47 and 48. The seat cushion portion 21 and the seat back portion 31 are configured to be foldable about the support shafts 47 and 48. The support shafts 47 and 48 are included in the above-mentioned rotation device. The seat cushion portion 21 and the seat back portion 31 are installed on the vehicle's floor panel via the rotation device.

The locking mechanism 43 is provided integrally with the right side edge 35c. The locking mechanism 43 has an internal fitting claw (not illustrated). The fitting claw engages with a fitting member 50 (see FIG. 4) provided on the vehicle side. Thus, the locking mechanism 43 restricts the rotation of the seat back frame 35 (seat back portion 31).

The seat back frame 38 has a similar configuration to the seat back frame 35, but is longer in the left-right direction than the seat back frame 35. The seat back frame 38 has a rectangular frame shape having an upper edge 38a, a lower edge 38b, and a pair of side edges 38c and 38d. More specifically, the seat back frame 38 has a rectangular frame shape in which the upper edge 38a and the lower edge 38b are longer than the pair of side edges 38c and 38d. The seat back frame 38 is formed, for example, from a metal material.

The seat back frame 38 also includes bearings 44 and 45 and a locking mechanism 46. The upper edge 38a, the lower edge 38b, and the pair of side edges 38c and 38d are formed from a hollow pipe (more specifically, a pipe having a D-shaped cross section).

The bearings 44 and 45 are arranged at the corners where the lower edge 38b is connected to the pair of side edges 38c and 38d. The bearings 44 and 45 are provided integrally with the pair of side edges 38c and 38d. The bearings 44 and 45 are supported by support shafts 48 and 49. The seat cushion portions 22 and 23 and the seat back portions 32 and 33 are configured to be foldable about the support shafts 48 and 49. The support shafts 48 and 49 are included in the above-mentioned rotation device. The seat cushion portions 22 and 23 and the seat back portions 32 and 33 are installed on the vehicle's floor panel via the rotation device.

The locking mechanism 46 is provided integrally with the left side edge 38d. The locking mechanism 46 has a similar configuration to the locking mechanism 43, and restricts the rotation of the seat back frame 38 (seat back portions 32 and 33).

### Configuration of Resin Plates 36 and 39

As illustrated in FIG. 6, the resin plate 36 is formed from resin and has a plate body 51, a locking claw 52, and abutment ribs 53 and 54. The plate body 51 is formed in the shape of a flat plate. The plate body 51 has a rectangular outer shape that covers the rear side 3b (see FIGS. 2A and 4) of the seat back frame 35.

The locking claw 52 is formed on the plate body 51. The resin plate 36 has a plurality of the locking claws 52. The locking claws 52 are arranged at positions to lock the four edges (the upper edge 35a, the lower edge 35b, and the pair of side edges 35c and 35d) of the seat back frame 35. The locking claws 52 lock the four edges of the seat back frame 35. As a result, the resin plate 36 is mounted to the seat back frame 35 via the locking claws 52. In other words, the resin plate 36 is supported by the seat back frame 35.

The abutment ribs 53 and 54 are formed on the plate body 51. The resin plate 36 has a plurality of the abutment ribs 53 (ribs) and a plurality of the abutment ribs 54 (ribs). The abutment ribs 53 are arranged at positions protruding toward the upper edge 35a, the lower edge 35b, and the pair of side edges 35c and 35d of the seat back frame 35. Furthermore, the abutment ribs 54 are arranged at positions protruding toward the locking mechanism 43.

The resin plate 39 has a similar configuration to the resin plate 36, but is longer in the left-right direction than the resin plate 36. The resin plate 39 is formed from resin and has a plate body 56, a locking claw 57, and abutment ribs 58 and 59 (ribs). The plate body 56 is formed in the shape of a flat plate. The plate body 56 has a rectangular outer shape that covers the rear side 3b (see FIGS. 2A and 4) of the seat back frame 38.

The locking claw 57 is formed on the plate body 56. The resin plate 39 has a plurality of the locking claws 57. The locking claws 57 are arranged at positions to lock the four edges (the upper edge 38a, the lower edge 38b, and the pair of side edges 38c and 38d) of the seat back frame 38. The locking claws 57 lock the four edges of the seat back frame 38 in the same manner as the locking claws 52. As a result, the resin plate 39 is mounted to the seat back frame 38 via the locking claws 57. In other words, the resin plate 39 is supported by the seat back frame 38.

The abutment ribs 58 and 59 are formed on the plate body 56. The resin plate 39 has a plurality of the abutment ribs 58 and a plurality of the abutment ribs 59. The abutment ribs 58 are arranged at positions protruding toward the upper edge 38a, the lower edge 38b, and the pair of side edges 38c and 38d of the seat back frame 38. Furthermore, the abutment ribs 59 are arranged at positions protruding toward the locking mechanism 46.

### Configuration of Locking Claws 52 and 57 and Abutment Ribs 58 and 59

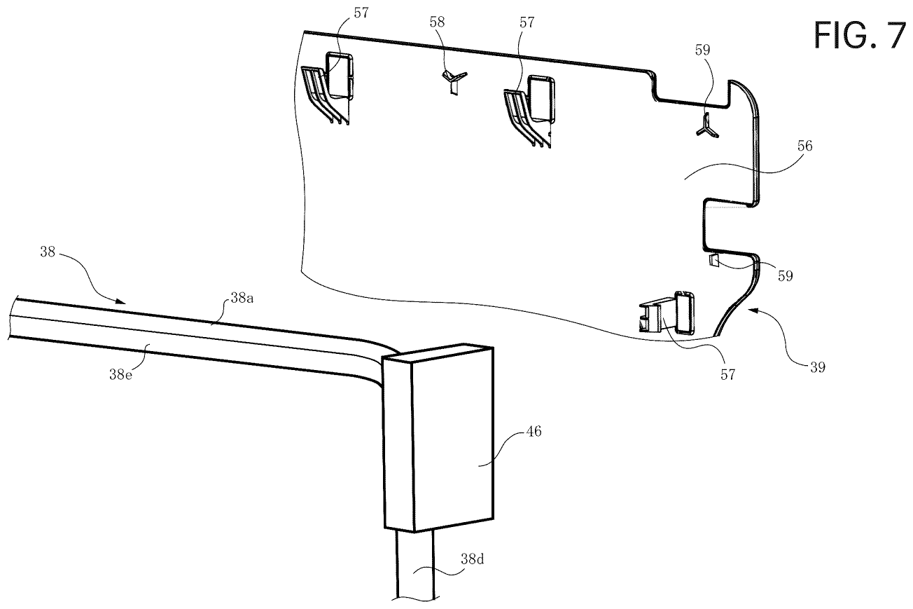

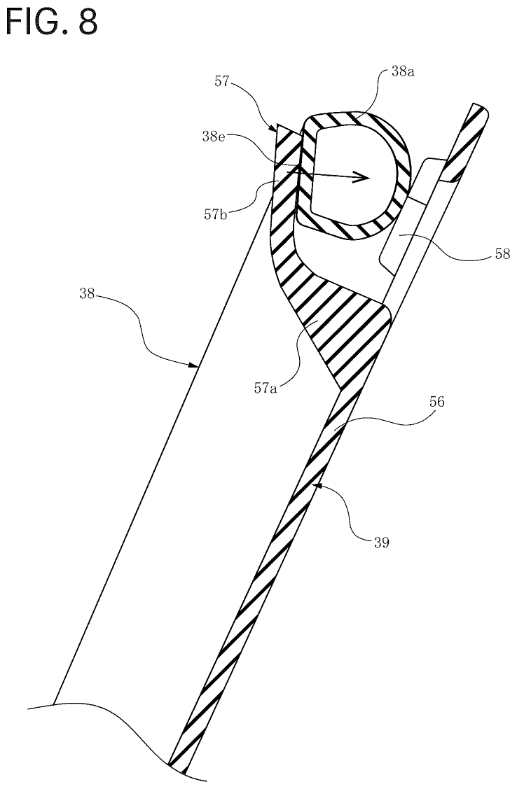

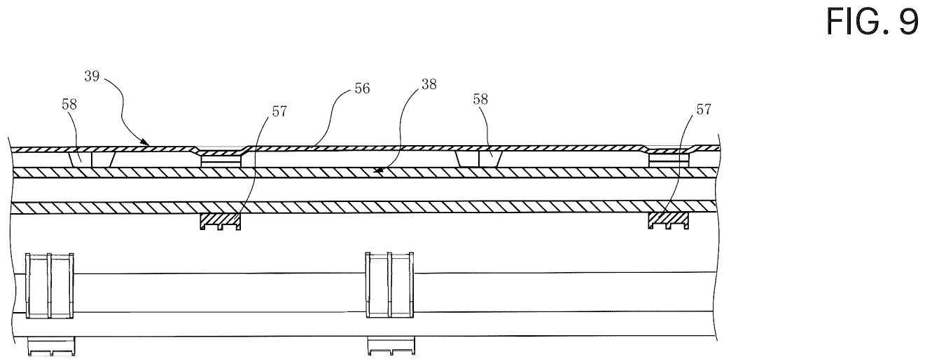

The detailed shapes and arrangements of the locking claws 52 and 57 and the abutment ribs 58 and 59 will be described below with reference to FIGS. 7 to 9. FIG. 7 is a partially enlarged view of FIG. 6. FIG. 8 is a partially enlarged view of FIG. 4. FIG. 9 is a cross-sectional view taken along line IX-IX in FIG. 5.

As illustrated in FIGS. 7 and 8, the locking claws 57 are L-shaped locking claws each comprised of a protruding piece 57a and a locking piece 57b. Note that the locking claws 52 of the resin plate 36 have a similar shape to the locking claws 57, and the abutment ribs 53 and 54 have a similar shape to the abutment ribs 58 and 59. Therefore, the locking claws 52 lock the four edges of the seat back frame 35 with a function and effect similar to that of the locking claws 57 locking the four edges of the seat back frame 38.

The protruding piece 57a is located inside the seat back frame 38 (within the space defined by the upper edge 38a, the lower edge 38b, and the pair of side edges 38c and 38d) and protrudes from the plate body 56 toward the seat back frame 38. The locking piece 57b intersects with the protruding piece 57a and protrudes from the inside of the seat back frame 38 toward the outside. Note that in FIG. 8, since the locking claw 57 that locks the upper edge 38a is engaged, the locking piece 57b protrudes from the inside of the upper edge 38a toward the outside.

The abutment rib 58 protrudes from the plate body 56 toward the seat back frame 38. The distance between the locking piece 57b and the plate body 56 is less than the dimension obtained by adding the height of the abutment rib 58 to the outer diameter of the upper edge 38a. This enables the locking claw 57 to exert an elastic force pressing the upper edge 38a (seat back frame 38) toward the plate body 56 (see FIG. 8).

Note that as described above, the upper edge 38a is a pipe having a D-shaped cross section, in other words, has a flat surface 38e on a portion of its outer peripheral surface. The locking piece 57b is disposed at a position facing the flat surface 38e. Thus, when the locking claw 57 locks the upper edge 38a, the locking piece 57b abuts against the flat surface 38e. This makes it easier for the locking claw 57 to press the upper edge 38a (the seat back frame 38) toward the rear side 3b.

The locking claws 57 for locking the three edges (lower edge 38b and pair of side edges 38c and 38d) other than the upper edge 38a also lock the lower edge 38b and the pair of side edges 38c and 38d with a configuration similar to the examples illustrated in FIGS. 7 and 8. Furthermore, the four edges (upper side 35a, lower edge 35b, and pair of side edges 35c and 35d) constituting the seat back frame 35 are also formed with flat surfaces 35e (see FIG. 6) similar to the flat surface 38e.

Furthermore, the resin plate 39 includes the locking claws 57 that are equal to or greater than the number of the four edges (upper edge 38a, lower edge 38b, and pair of side edges 38c and 38d) of the seat back frame 38. As described above, the locking claws 57 are arranged at positions to lock the four edges of the seat back frame 38. More specifically, the resin plate 39 has three locking pieces 57 arranged at intervals along each of the upper edge 38a and the lower edge 38b, which are the long edges, and two locking pieces 57 arranged at intervals along each of the pair of side edges 38c and 38d, which are the short edges.

The resin plate 39 includes the abutment ribs 58 and 59 that are equal to or greater than the number of the locking claws 57. As described above, the abutment ribs 58 are arranged at positions protruding toward the upper edge 38a, lower edge 38b, and pair of side edges 38c and 38d of the seat back frame 38, and the abutment ribs 59 are arranged at positions protruding toward the locking mechanism 46. Further, the abutment ribs 58 and 59 are arranged between the locking claws 57 along the upper edge 38a, the lower edge 38b, the pair of side edges 38c and 38d, and the locking mechanism 46. Furthermore, the abutment ribs 58 and 59 are peak-shaped protruding pieces protruding from the plate body 56 toward the front side 3a. Additionally, when viewed from the front side 3a, the resin plate 39 is formed in a Y-shape (comprised of three ribs extending radially) (see FIG. 7). This allows for increased contact area with the seat back frame 38 while achieving a lighter weight than a typical rib shape. Note that the shape of the abutment ribs 58 and 59 is not limited to the illustrated examples, and any shape that can protrude from the plate body 56 toward the front side 3a and abut against the seat back frame 38 is acceptable, for example, circular or rectangular.

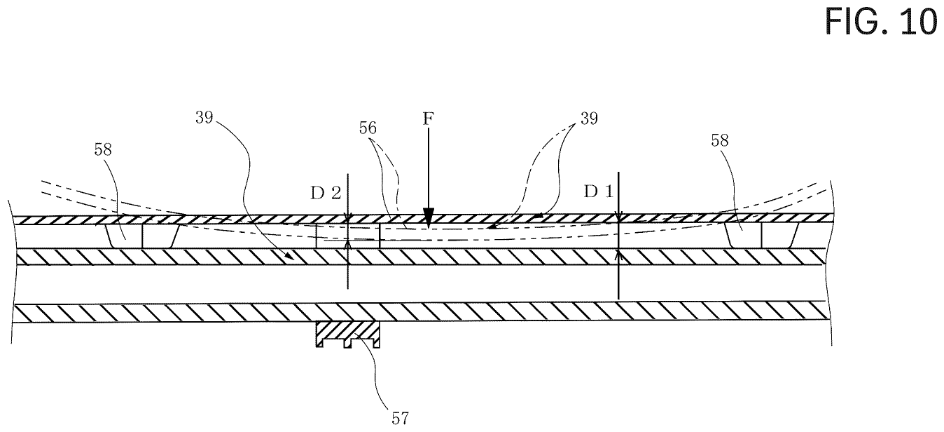

As illustrated in FIG. 10, when the resin plate 39 is mounted to the seat back frame 38 via the locking claws 57, the plurality of abutment ribs 58 and 59 abut against the upper edge 38a, the lower edge 38b, the pair of side edges 38c and 38d, and the locking mechanism 46 (seat back frame 38), and a predetermined gap D1 is formed between the seat back frame 38 and the plate body 56. The predetermined gap D1 is greater than the dimension obtained by adding a maximum deflection D2 of the plate body 56 when subjected to an external force F in a direction perpendicular to the in-plane direction to the dimensional tolerance of the plate body 56. Note that in the example illustrated in FIG. 10, the external force F is applied in a direction perpendicular to the in-plane direction of the plate body 56.

For example, when the plate body 56 has a thickness of 2 mm and the spacing between the abutment ribs 58 is 260 mm, the maximum deflection D2 of the plate body 56 under the external force F is 3.81 mm. The predetermined gap D1 is greater than the dimension obtained by adding the dimensional tolerance of the plate body 56 to the value of the maximum deflection D2. Note that FIG. 10 illustrates the maximum deflection D2 when the abutment ribs 58 support both ends of the plate body 56 in a two-point support configuration. However, the maximum deflection may also be calculated assuming a one-point support configuration where the abutment ribs 58 support only one end of the plate body 56.

Next, the effects of the present embodiment configured as above will be described.

In the present embodiment, when the resin plates 36 and 39 are mounted to the seat back frames 35 and 38 via the locking claws 52 and 57, the predetermined gap D1 is formed between each of the seat back frames 35 and 38 and the corresponding one of the plate bodies 51 and 56. Further, the predetermined gap D1 is greater than the dimension obtained by adding the maximum deflection D2 when the plate bodies 51 and 56 are subjected to an external force F to the dimensional tolerance of the plate bodies 51 and 56. Therefore, for example, even if the plate bodies 51 and 56 deflect due to the external force F, such as when cargo is placed on the resin plates 36 and 39 or a person's body impacts them, the plate bodies 51 and 56 do not come into contact with the seat back frames 35 and 38. It is therefore possible to prevent abnormal noises generated when the resin plates 36 and 39 collide with the seat back frames 35 and 38.

The resin plates 36 and 39 include a plurality of the locking claws 52 and a plurality of the locking claws 57, respectively. The number of the locking claws 52 and the number of the locking claws 57 are equal to or greater than the number of four edges forming the rectangles of the seat back frames 35 and 38, respectively, and are arranged at positions to lock the four edges of the seat back frames 35 and 38, respectively, thereby allowing the four sides of the seat back frames 35 and 38 to abut against the abutment ribs 53 and 58, respectively. Thus, since the predetermined gap D1 is reliably formed between each of the seat back frames 35 and 38 and the corresponding one of the plate bodies 51 and 56, it is possible to prevent abnormal noises generated when the resin plates 36 and 39 collide with the seat back frames 35 and 38.

Furthermore, the resin plate 36 includes the abutment ribs 53 and 54 equal to or greater in number than the locking claws 52, and the resin plate 39 includes the abutment ribs 58 and 59 equal to or greater in number than the locking claws 57. The abutment ribs 53 and 54 are arranged between each pair of the locking claws 52 along the seat back frame 35, and the abutment ribs 58 and 59 are arranged between each pair of the locking claws 57 along the seat back frame 38. Thus, the seat back frames 35 and 38, which are respectively pressed by the locking claws 52 and 57, reliably abut against the abutment ribs 53 and 54, and 58 and 59. Therefore, it is possible to prevent abnormal noises generated when the resin plates 36 and 39 collide with the seat back frames 35 and 38.

Furthermore, the locking claws 52 and 57 abut against the flat surfaces 35e and 38e, respectively, each of which is formed on a portion of the outer peripheral surface among the four edges forming the corresponding seat back frame 35 or 38. Consequently, the locking claws 52 and 57 easily press the seat back frames 35 and 38 toward the rear side 3b.

Moreover, due to the pressure exerted by the locking claws 52 and 57, the abutment ribs 54 and 59 are arranged at positions protruding toward the locking mechanisms 43 and 46 included in the seat back frames 35 and 38, respectively. This arrangement enhances the layout flexibility of the abutment ribs 54 and 59 and ensures reliable abutment between the seat back frame 35 and the abutment rib 54 and between the seat back frame 38 and the abutment rib 59.

Note that the present invention is not limited to the above-described embodiment, and various modifications are possible within the scope of the gist of the present invention. All technical matters included in the technical ideas described in the claims are covered by the present invention. The above-described embodiment illustrates an preferred example, but a person skilled in the art can achieve various alternatives, modifications, variations, combinations, or improvements from the contents disclosed in this specification, and these are included within the technical scope described in the appended claims.

For example, in the above embodiment, the four sides of each of the seat back frames 35 and 38 are formed from a pipe having a D-shaped cross-section, but this is not limited thereto; they may also be formed from a pipe having a circular or polygonal cross-section. Furthermore, while the above embodiment applies the invention to a vehicle seat for rear seats, it is not limited thereto; the invention may also be applied to a vehicle seat for front seats. Furthermore, while the above embodiment illustrates a configuration including a seat back frame and a resin plate supported by the seat back frame, the present invention is not limited to this, and may be applied to a configuration including a seat cushion frame (frame) and a resin plate supported by the seat cushion frame.

What is claimed is:

1. A vehicle seat comprising: a frame; and a resin plate supported by the frame,
the resin plate having:
a plate body configured to cover a rear side of the frame;
a locking claw configured to lock the frame; and
a plurality of ribs protruding toward the frame, wherein
when the resin plate is mounted to the frame via the locking claw, the plurality of ribs abut against the frame, and a predetermined gap is formed between the frame and the plate body, and
the predetermined gap is greater than a dimension obtained by adding a maximum deflection of the plate body when subjected to an external force in a direction perpendicular to an in-plane direction to a dimensional tolerance of the plate body.

2. The vehicle seat according to claim 1, wherein
the resin plate includes
a plurality of the locking claws,
the frame is formed to be a rectangle, and
the locking claws are provided in a number equal to or greater than the number of four edges forming the rectangle of the frame and are arranged at positions to lock the four edges.

3. The vehicle seat according to claim 2, wherein
the resin plate includes
the ribs equal to or greater in number than the locking claws, and
the ribs are arranged between each pair of the locking claws along the frame.

4. The vehicle seat according to claim 1, wherein
the frame is constituted by a pipe having a flat surface on a portion of the outer peripheral surface of the pipe, and
the locking claw abuts against the flat surface.

5. The vehicle seat according to claim 1, wherein
the frame includes a locking mechanism configured to restrict movement of the frame relative to the vehicle, and
the ribs are arranged at positions protruding toward the locking mechanism.
